(19) United States
(12) Patent Application Publication
(10) Pub. No.: US 2015/0032649 A1
(43) Pub. Date: Jan. 29, 2015

(54) PROVIDING A WEBSITE FOR CERTIFYING A SALES REPRESENTATIVE

(71) Applicants: David L. Austin, Kaysville, UT (US); Karen Austin, Kaysville, UT (US)

(72) Inventors: David L. Austin, Kaysville, UT (US); Karen Austin, Kaysville, UT (US)

(21) Appl. No.: 14/445,036

(22) Filed: Jul. 28, 2014

Related U.S. Application Data
(60) Provisional application No. 61/859,218, filed on Jul. 27, 2013.

(51) Int. Cl. G06Q 30/00

(52) U.S. Cl. CPC G06Q 30/018
USPC 705/317

(57) ABSTRACT

A website is provided for certifying a sales representative. A website can provide an interface through which reps can register to become certified. Certification implies that the rep has agreed to abide by various rules when visiting a provider. Once registered, a rep can be listed on the website along with information that identifies the product or service that the rep markets. The website can also provide functionality for a provider to report when a rep has violated a rule during a visit. The website can track a number of violations that a rep has committed and, after the number exceeds a threshold, can revoke the certification of the rep so that rep will no longer be listed as a certified rep on the website. A provider may therefore rely on the website to identify reps that will provide value to the provider during a visit.

### CROSS-REFERENCE TO RELATED APPLICATIONS

This application claims the benefit of U.S. Provisional Patent Application No. 61/859,218 which was filed on Jul. 27, 2013.

### BACKGROUND

Many companies employ sales representatives (“reps”) to market their products or services to individuals or companies (“providers”) that will in turn recommend, sell, or otherwise promote the products or services. For example, most pharmaceutical companies employ reps who meet with doctors, nurses, administrators, or other medical providers to promote the companies' drugs. Typically, reps will either schedule a time to meet with a provider or will simply visit the provider's facilities to inquire about a provider's availability. In either case, if a rep is able to meet with a provider, the rep can provide information about a product or service that his company has to offer.

In many cases, a rep can provide valuable information that can assist the provider in determining whether and when to promote the marketed product or service. In such cases, the provider will view the rep's visit as worthwhile. However, in other cases, a rep's visit may be viewed as a waste of time. Such may be the case when the provider receives too many visits promoting the same product or service or when the rep fails to provide valuable or reliable information about the product or service. Even if the rep provides valuable information during a visit, the provider may still view the visit as a nuisance if it lasts too long.

### BRIEF SUMMARY

The present invention extends to methods, systems, and computer program products for providing a website or other user interface for certifying a sales representative. A website can provide an interface through which reps can register to become certified. Certification implies that the rep has agreed to abide by various rules when visiting a provider. Once registered, a rep can be listed on the website along with information that identifies the product or service that the rep markets. Providers may then access the website to find a certified rep that can provide information about a particular product or service. The website may also provide functionality that allows providers and reps to communicate including to schedule an appointment for a rep to visit a provider.

The website can also provide functionality for a provider to report when a rep has violated a rule during a visit. The website can track a number of violations that a rep has committed and, after the number meets a threshold, can revoke the certification of the rep so that the rep will no longer be listed as a certified rep on the website. A provider may therefore rely on the website to identify reps that will provide value to the provider during a visit.

In one embodiment, the present invention is implemented as a method for ensuring that a rep provides value to a provider. User input is received from a rep. The user input comprises the rep's agreement to abide by one or more rules when visiting a provider to market a product or service. In response to the input, an indication that the rep is certified is listed in a user interface. The listing also indicates a product or service that the rep will market when making a visit to a provider. An option is provided for a provider to report that the rep has violated the one or more rules during a visit to the provider. The certification of the rep is revoked when the number of violations for which the rep has been reported meets a threshold such that the rep is no longer listed in the user interface as being certified.

In another embodiment, the present invention is implemented as a method for ensuring that a rep provides value to a provider. A listing of a rep that is certified to market a product or service is listed in a user interface. The listing identifies the product or service that the rep is certified to market. User input is received from a provider that has been visited by the rep to market the product or service. The user input indicates that the rep violated at least one of one or more rules governing the certification of reps. It is determined that the rep has committed a number of violations that meets a threshold. The certification of the rep is then revoked such that the rep is no longer listed in the user interface as being certified to market the product or service.

In another embodiment, the present invention is implemented as a method for ensuring that a rep provides value. A listing of a plurality of reps that have been certified to market a drug is displayed in a user interface. Each rep is listed with a drug that the rep markets. A rep is certified by agreeing to abide by one or more rules when visiting a provider to market a drug. A listing of a plurality of providers that have registered to receive visits from certified reps is also displayed in the user interface. An option is provided in the user interface for a rep to schedule a visit with a provider during which the rep will discuss the drug that the rep markets. An option is also provided in the user interface for a provider to report a violation of the one or more rules that a rep commits during a visit to the provider.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computing environment in which the present invention can be implemented;

FIG. 2 illustrates an example webpage that lists a number of reps along with the drug that each rep markets;

FIG. 3 illustrates an example webpage that lists a number of providers that have registered to receive visits from certified reps;

FIG. 4 illustrates an example webpage that lists drugs for which a provider has agreed to be visited along with information about a number of visits that the provider has received and is willing to receive;

FIG. 5 illustrates a flowchart of an example method for ensuring that a rep provides value to a provider; and

FIGS. 6A-6G illustrate various screenshots of a website that implements one or more embodiments of the present invention.

### DETAILED DESCRIPTION

Embodiments of the present invention may comprise or utilize special purpose or general-purpose computers including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system.

Computer-readable media is categorized into two disjoint categories: computer storage media and transmission media. Computer storage media (devices) include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other similarly storage medium which can be used to store desired program code means in the form of computer-executable instructions or data structures and which can be accessed by a general purpose or special purpose computer. Transmission media include signals and carrier waves.

Computer-executable instructions comprise, for example, instructions and data which, when executed by a processor, cause a general purpose computer, special purpose computer, or special purpose processing device to perform a certain function or group of functions. The computer executable instructions may be, for example, binaries, intermediate format instructions such as assembly language or P-Code, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like.

The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices. An example of a distributed system environment is a cloud of networked servers or server resources. Accordingly, the present invention can be hosted in a cloud environment.

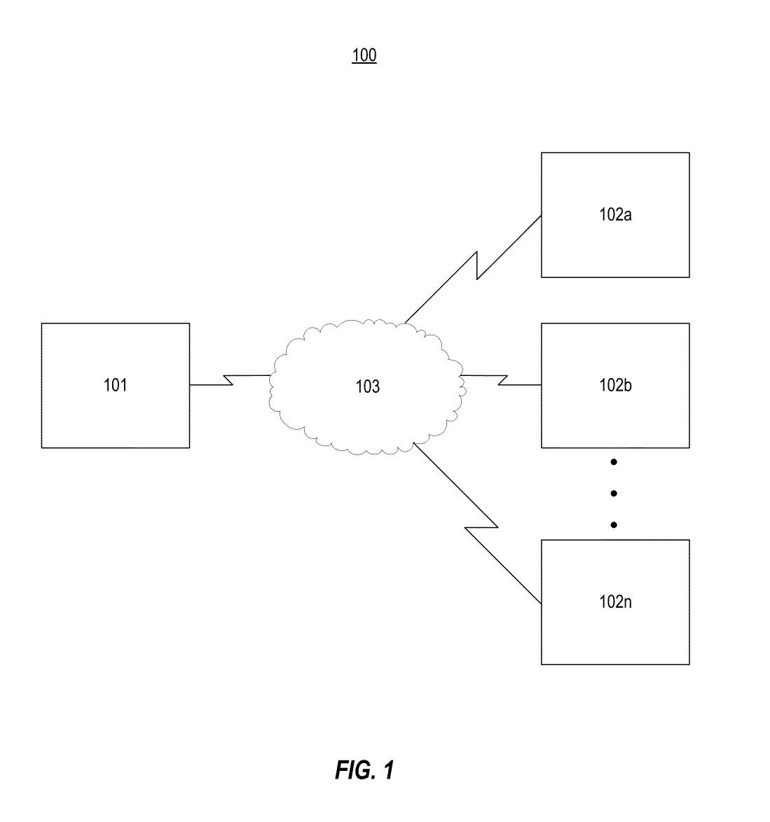

FIG. 1 illustrates an example computer environment 100 in which the present invention can be implemented. Computer environment 100 includes a server system 101, consumer computing devices 102a-102n, and a network 103 interconnecting server system 101 with consumer computing devices 102a-102n. Server system 101 can represent any number and configuration of server systems, devices, and/or components. For example, server system 101 can be a single server computing device or a cloud of server components. Similarly, consumer computing devices 102a-102n can represent the many different types of devices that can communicate with server system 101 via network 103. For example, consumer computing devices 102a-102n may represent desktop computers, laptop computers, tablets, smart phones, etc. Network 103 can typically be the internet although other network connections, such as local connections, could also be employed.

In a typical implementation, server system 101 can provide a website that consumer computing devices 102a-102n may access. In other implementations, server system 101 can communicate with a dedicated application executing on consumer computing devices 102a-102n (e.g. a mobile application) to allow the dedicated application to display similar information as would be displayed on a website. The following discussion of the invention will describe a browser-based implementation of the invention. However, the invention should not be limited to any particular implementation or to any particular location where the functionality is performed.

The following discussion will refer to medical reps and providers where the reps market drugs to the providers so that the providers will prescribe or recommend the drugs to patients. However, the techniques of the present invention can also be employed in other industries where reps market products or services to providers that may directly use, sell, or otherwise promote the products or services. In the medical context, a provider should be construed to include any person or entity that may prescribe or recommend a drug to an individual.

In accordance with embodiments of the present invention, a website can be provided that lists reps that have been certified for visiting providers to market drugs. The website can provide one or more rules that define the certification standard. Certification therefore denotes that a rep has agreed to abide by the one or more rules when visiting a provider to market a drug. Certification also implies that the rep has not violated the rules to the point that revocation of the certification is warranted.

In one or more embodiments of the invention, the one or more rules that define the certification standard can include a Number of Visits rule, a Duration of Visit rule, a Balance rule, and/or a New Detail rule. The Number of Visits rule provides a maximum number of visits that a provider may receive during a period of time in which the same drug is marketed. For example, if the maximum number of visits is two and the period of time is a month, the Number of Visits rule would prevent a drug from being marketed to a provider more than two times during a month. In some embodiments, the Number of Visits rule applies regardless of which rep has visited the provider to market the drug. For example, if the doctor has already received two visits during the month where a drug was marketed, any rep, including those that did not previously visit the doctor to market the drug, would be prohibited from visiting the doctor to market the drug during that month. In this way, the doctor can be assured that he will not be visited more than the maximum number of times even if multiple reps market the same drug. In some embodiments, the Number of Visits rule may specify a required duration of time between visits rather than a maximum number of visits per period of time. This can ensure that the visits are more evenly spaced. In some embodiments, the maximum number of visits during which a particular drug is marketed can be specified by the provider. The maximum number may therefore vary by provider. The provider may also specify different maximum numbers for different drugs. For example, a provider may be willing to receive more visits for a newer drug than for an older drug.

The Duration of Visit rule provides a maximum duration for a visit. For example, the Duration of Visit rule can specify that a visit should be no longer than two minutes. This rule can therefore reassure providers that a visit will not require too much time, and will also encourage reps to be more efficient in providing information about the drug.

The Balance rule requires that the rep provide both positive and negative information about the drug during a visit. For example, to comply with the Balance rule, the rep may provide one or two benefits of the drug along with one or two side effects of the drug. If a rep were to only provide positive information about the drug, the rep would be in violation of this rule.

The New Detail rule requires that the rep present a new detail of the drug during a visit that was not presented in a previous visit. If a rep were to provide the same information about the drug in two consecutive visits, the rep would be in violation of this rule.

A rep desiring to become certified can access the website to provide relevant information and to agree to abide by the rule. In some embodiments, the website can collect the reps name and contact information as well as any drugs that the rep markets. The website may then list which reps are certified for a particular drug.

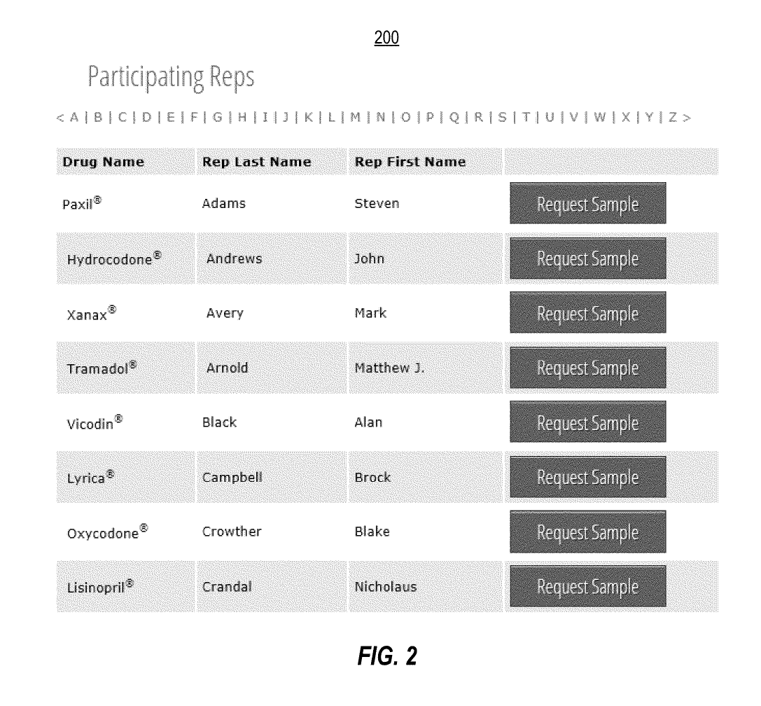

FIG. 2 provides an example of a webpage 200 that lists drugs along with the certified reps that market the drugs. For example, the drug Paxil® is shown as being marketed by Steven Adams. Therefore, by accessing the website, a provider can identify a certified rep who can provide information about Paxil® and who will be governed by the rules of certification. In webpage 200, for each drug, a Request Sample button is provided to allow the provider to contact the rep to request a visit.

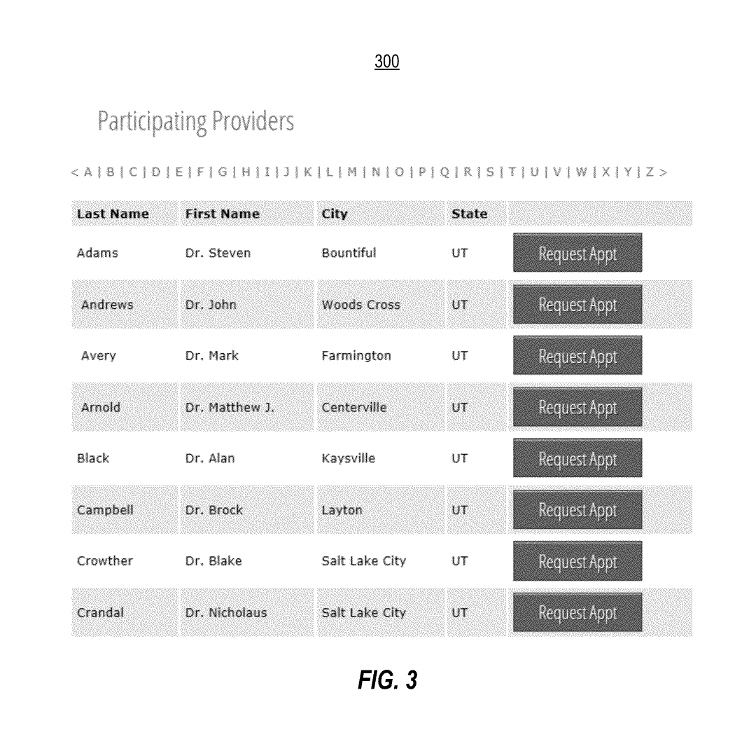

FIG. 3 provides an example of a webpage 300 that lists various providers that have registered with the website to receive visits from certified reps. As shown, webpage 300 includes a Request Appt button alongside each provider. The website can restrict access to webpage 300 so that only certified reps can request an appointment to visit a provider. In some embodiments, requesting an appointment can comprise requesting a sample of the drug marketed by the rep.

In some embodiments, the website can maintain a record of the number of times a provider has been visited to market each of a number of drugs. For example, when a rep selects a provider, a list of which drugs have been marketed to the provider during a time period may be displayed along with the number of times that the drug was marketed during the time period. In this way, a rep can know whether a provider has been visited the maximum number of times to market a particular drug during a particular time period.

To facilitate tracking visits, when requesting an appointment through the website, the rep can be prompted to input the drug that will be marketed during the visit. Then, after the time of the visit, the website can request that the rep confirm whether the visit occurred and whether the drug was marketed during the visit. The website may also provide the ability for the rep to report a visit, including specifying which drug was marketed during the visit, even in cases where the visit is not scheduled through the website.

In some embodiments, a provider can specify times during which a certified rep can schedule a visit to the provider. For example, a provider may specify availability for visits on Tuesdays and Thursdays between the hours of 10:00 and 2:00. In such cases, when a certified rep selects the Request Appt button for that provider, the provider's available times can be presented to the rep to allow the rep to schedule a visit within the available times. In some cases, a provider may specify a requirement that a visit be scheduled, while in others, a provider may provide available times for scheduling a visit, but may also accept unscheduled visits. In either case, the website can notify reps of a provider's preferences and/or restrictions on visits.

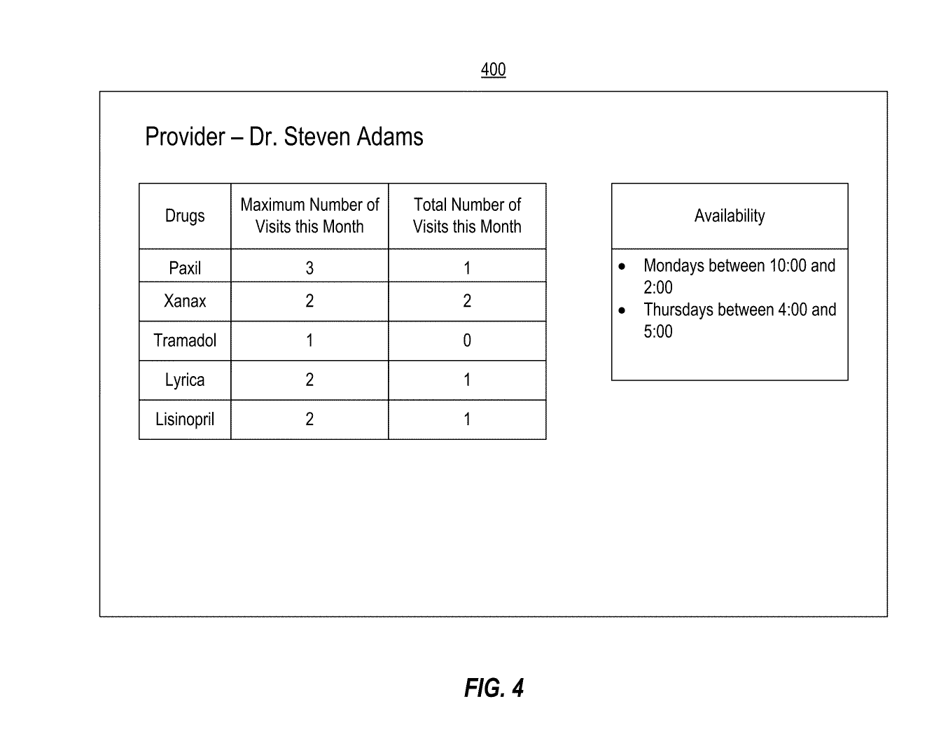

FIG. 4 provides an example of a webpage 400 for displaying information about visits that a provider is willing to receive and has already received. As shown, the provider, Dr. Steven Adams, has indicated a willingness to receive visits for Paxil®, Xanax®, Tramadol, Lyrica®, and Lisinopril. For each of these drugs, Dr. Adams has specified a maximum number of visits of 3, 2, 1, 2, and 2 respectively during each month and has received 1, 2, 0, 1, and 1 visits respectively. Webpage 400 also lists when Dr. Adams has indicated that he is available to receive visits. Accordingly, a rep can access webpage 400 to identify whether and when Dr. Adams can be visited for a particular drug. In this manner, webpage 400 can assist the rep is complying with the Number of Visits rule. Webpage 400 can be particularly useful when multiple reps market the same drug.

In some embodiments, a provider may specify availability for lunch visits. In such cases, the website can inform reps that the provider is available for a visit over lunch. In some embodiments, a provider may also specify that, to schedule a lunch visit, the rep must be willing to provide lunch. In such cases, failure to provide lunch may constitute a violation of a rule governing the certification of reps. The website may also request that reps report an amount spent on providing lunch during lunch visits to providers and maintain a record of the total amount a rep has spent on lunches. In some embodiments where multiple reps are employed by the same company, a record of the total amount spent by all reps of the company can be maintained. These amounts can be presented on the website for the providers and/or reps to review, and can assist the providers in verifying whether a rep is spending too much marketing a drug or drugs to the provider.

The website can also provide functionality for a provider to report a violation of the rules governing certification of a rep. For example, after a provider has been visited by a rep, if the rep committed a violation, the provider can access the website to report the violation. To report a violation, the provider can identify the rep that visited the provider and specify the conduct that the provider believes constitutes a violation. If the violation is confirmed, the website can record the violation. In some embodiments, violations can be made visible to providers and/or other reps.

To facilitate reporting violations, the website may send communications to providers asking for feedback about a visit. For example, when a visit is scheduled through the website, the website can use the information provided to schedule the visit to send a communication such as an email to the provider. The communication can include various questions intended to confirm that the rep complied with each of the rules governing certification. For example, the communication can ask which drug was marketed, whether the drug was marketed to the provider previously during a time period, how long the visit was, whether the rep provided both positive and negative features of the drug, whether the rep provided a new detail about the drug, etc.

In some embodiments of the invention, the website can maintain the total number of violations that have been committed by a rep during a period of time so that the rep's certification can be revoked if he commits too many violations. For example, after three violations have been committed, a rep's certification can be revoked thereby preventing the rep from scheduling appointments with providers via the website. A rep whose certification has been revoked may also be removed from webpage 200 so that the rep is no longer represented as being certified to market a drug.

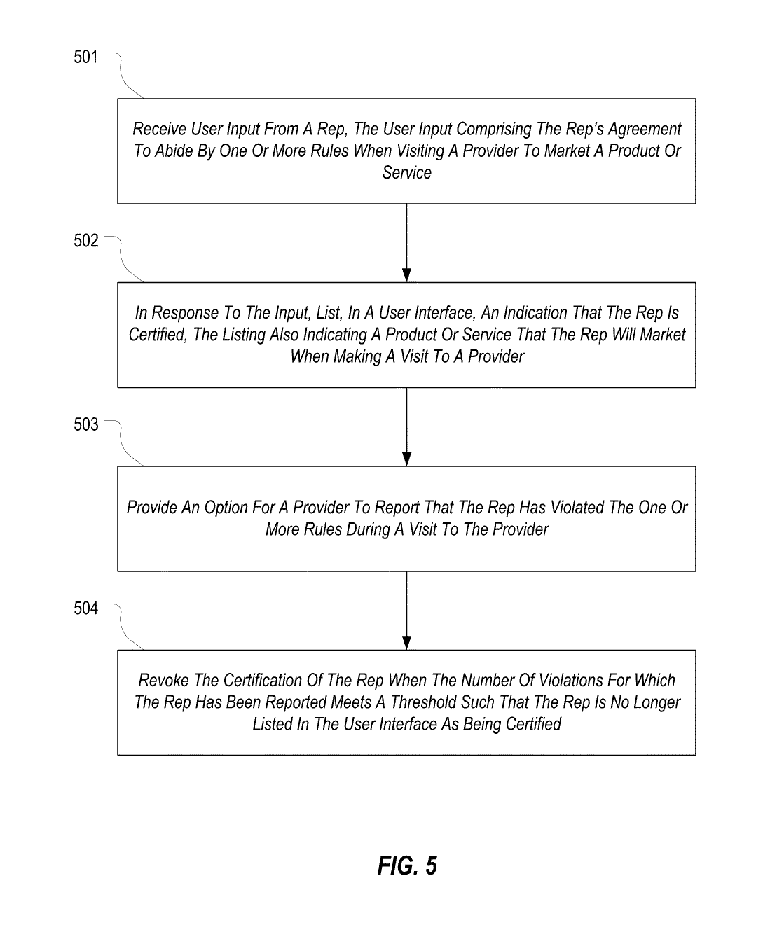

FIG. 5 provides a flowchart of an example method 500 for ensuring that a rep provides value to a provider. Method 500 can be implemented by server system 101.

Method 500 includes an act 501 of receiving user input from a rep. The user input comprises the rep's agreement to abide by one or more rules when visiting a provider to market a product or service. For example, server system 101 may provide a webpage through which a rep provides the user input to agree to abide by the rules governing certification to market a drug to a provider.

Method 500 includes an act 502 of, in response to the input, listing, in a user interface, an indication that the rep is certified. The listing also indicates a product or service that the rep will market when making a visit to a provider. For example, server system 101 may provide a webpage that lists the name of a certified rep along with a drug that the rep markets.

Method 500 includes an act 503 of providing an option for a provider to report that the rep has violated the one or more rules during a visit to the provider. For example, server system 101 may provide an interface through which a provider can report that a rep violated a rule when visiting the provider to market a drug.

Method 500 includes an act 504 of revoking the certification of the rep when the number of violations for which the rep has been reported meets a threshold such that the rep is no longer listed in the user interface as being certified. For example, server system 101 can determine that a rep has violated the rules governing certification three times during a particular time period and can revoke the rep's certification so that the rep is no longer listed on the webpage as being certified.

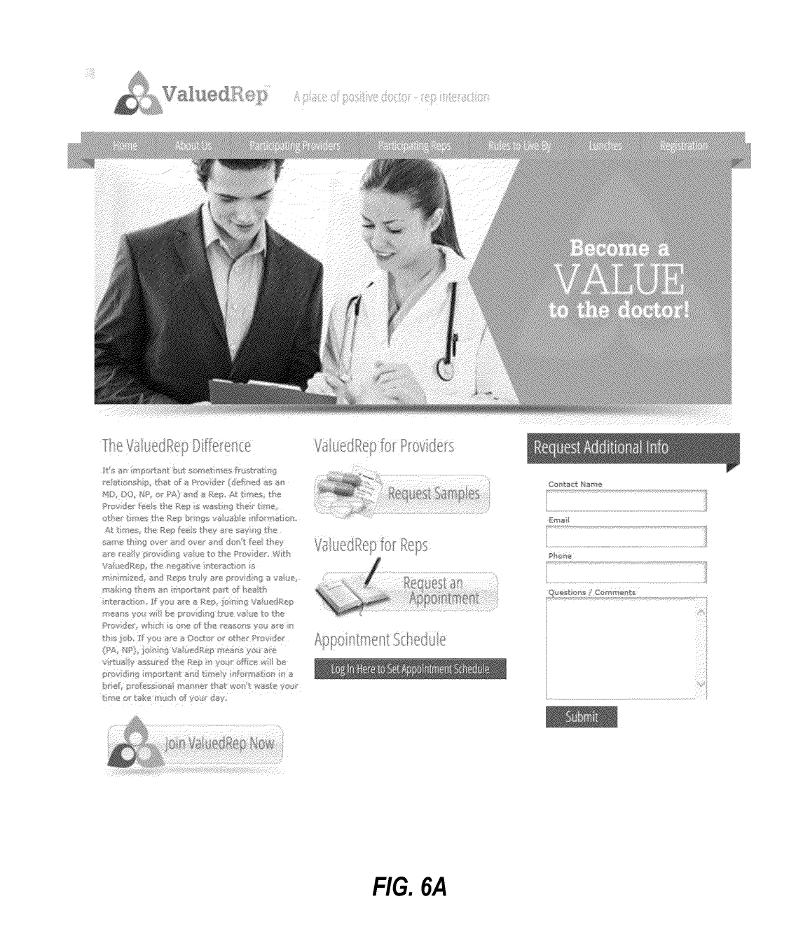

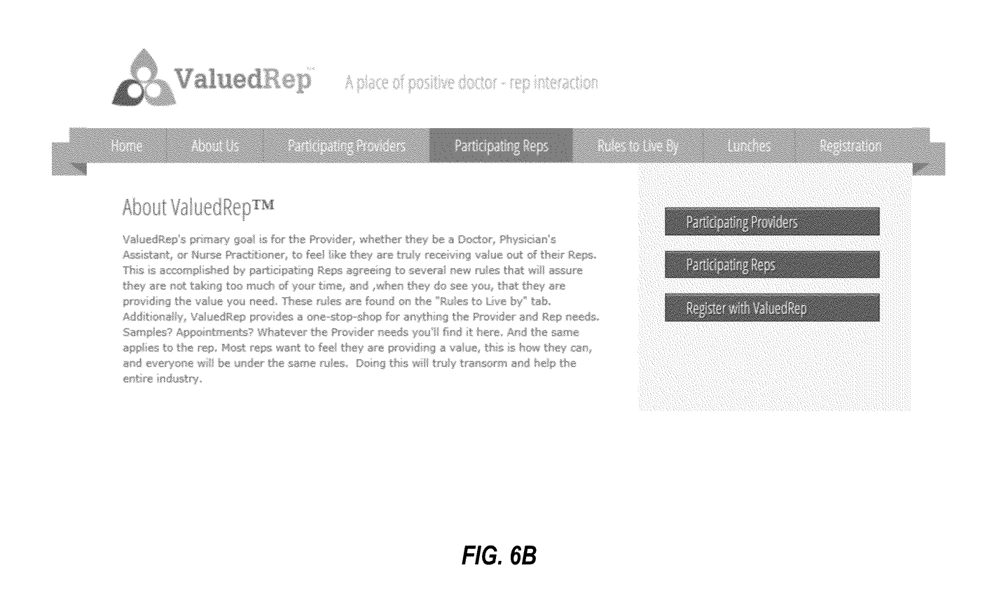

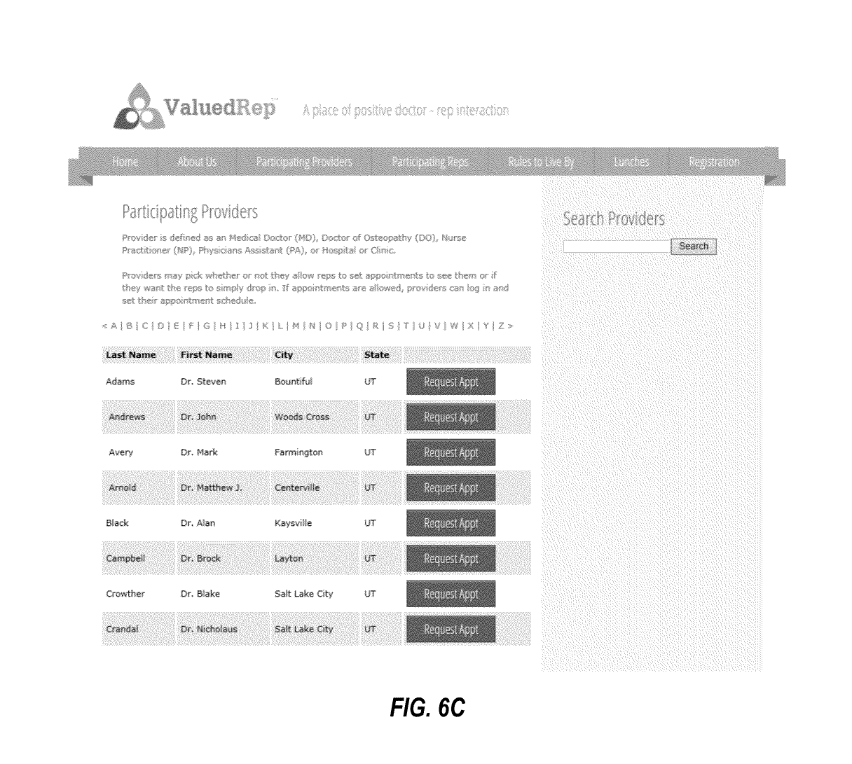

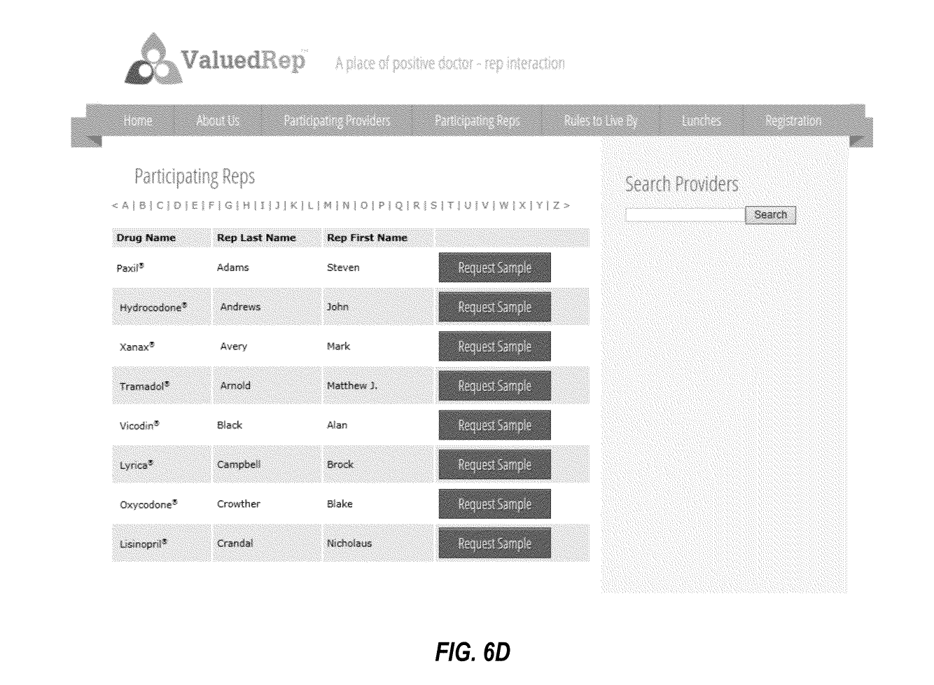

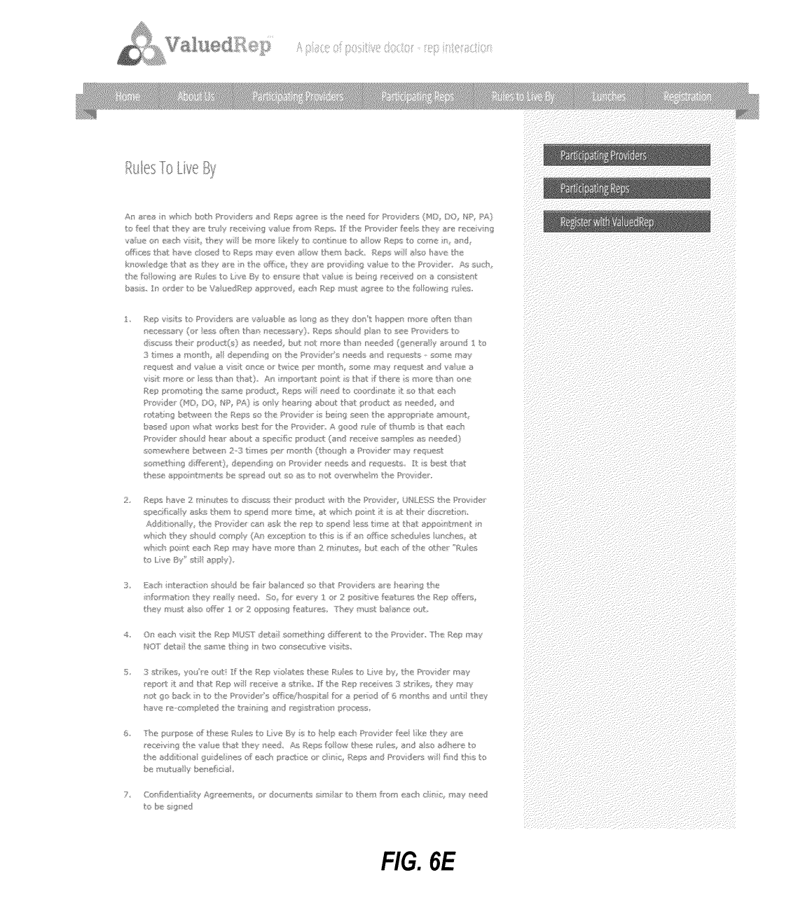

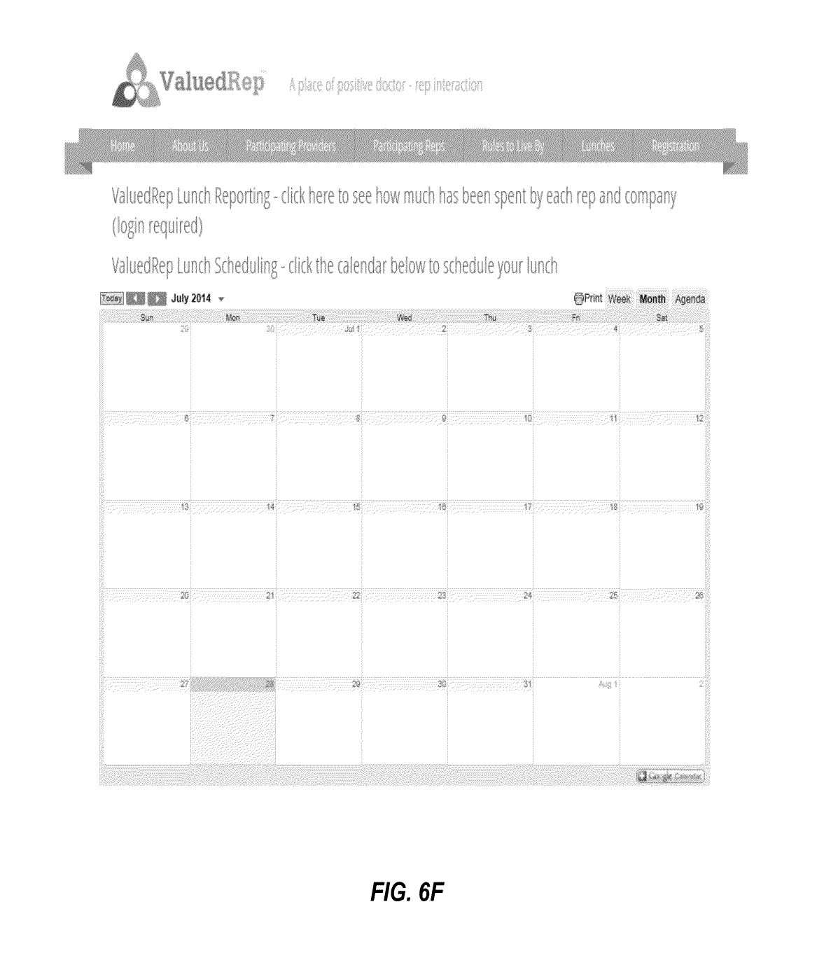

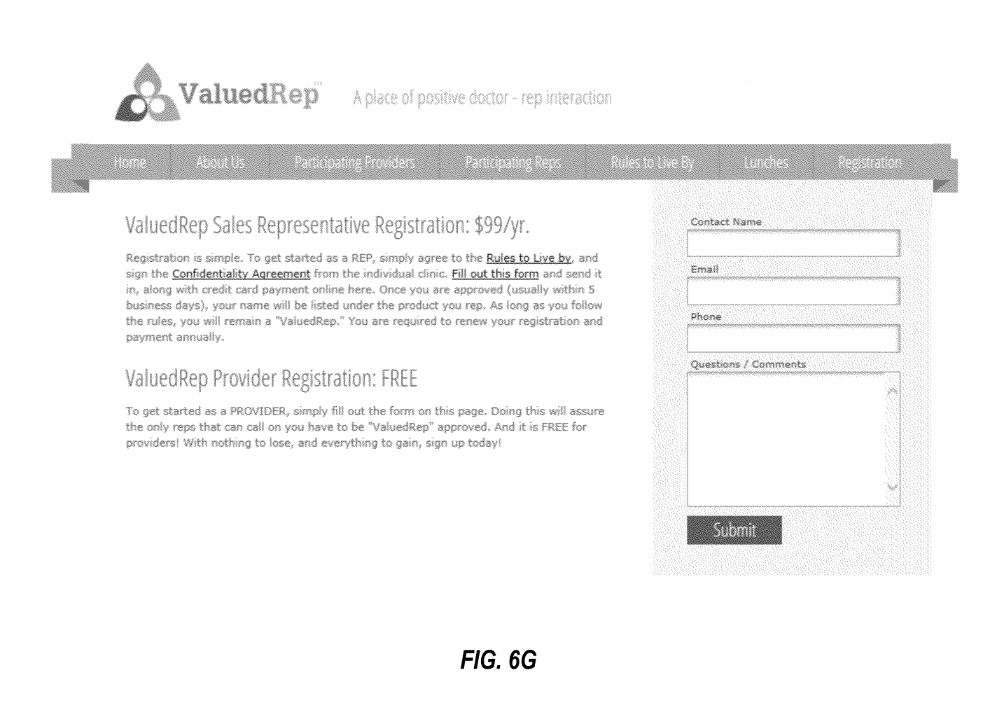

FIGS. 6A-6G illustrate screenshots of a website that implements one or more embodiments of the present invention. FIG. 6A illustrates a home screen that provides various options including an option for a provider to request samples from a certified rep and an option for a certified rep to request an appointment from a registered provider. FIG. 6B illustrates an About Us page that provides information about the website. FIG. 6C illustrates a webpage that lists participating providers and is similar to FIG. 3. FIG. 6D illustrates a webpage that lists certified reps and is similar to FIG. 2. FIG. 6E illustrates a webpage that lists the rules governing certification. FIG. 6F illustrates a webpage that can be used to schedule lunch appointments with providers. Finally, 6G illustrates a webpage that allows a rep or a provider to register with the website.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A method, implemented by a computer system, for ensuring that a rep provides value to a provider, the method comprising:
receiving user input from a rep, the user input comprising the rep's agreement to abide by one or more rules when visiting a provider to market a product or service;
in response to the input, listing, in a user interface, an indication that the rep is certified, the listing also indicating a product or service that the rep will market when making a visit to a provider;
providing an option for a provider to report that the rep has violated the one or more rules during a visit to the provider; and
revoking the certification of the rep when the number of violations for which the rep has been reported meets a threshold such that the rep is no longer listed in the user interface as being certified.

2. The method of claim 1, wherein the product or service is a drug.

3. The method of claim 1, wherein the one or more rules includes a rule that specifies a maximum number of visits that a provider can receive in which the same product or service is marketed, and wherein a rep violates the rule when visiting a provider after the provider has been visited the maximum number of times by any reps marketing the same product of service.

4. The method of claim 3, wherein the maximum number of times is between one and three times per month.

5. The method of claim 3, wherein the user interface provides an indication of the number of times that a provider has been visited by a rep marketing a particular product or service during a particular duration of time.

6. The method of claim 1, wherein the one or more rules includes a rule that specifies a maximum duration of a visit to a provider, and wherein a rep violates the rule when the rep's visit to a provider lasts longer than the maximum duration.

7. The method of claim 2, wherein the one or more rules includes a rule that specifies that a rep must provide positive features of the drug as well as negative features of the drug, and wherein a rep violates the rule when the rep fails to provide negative features of the drug.

8. The method of claim 1, wherein the one or more rules includes a rule that specifies that a rep must describe a feature of the product or service that was not described to the provider in a prior visit, and wherein a rep violates the rule when the rep fails to describe a feature of the product or service that was not described in the prior visit.

9. The method of claim 1, wherein the threshold comprises three violations.

10. The method of claim 1, further comprising:
listing, in the user interface, one or more providers that have registered to receive visits from certified reps.

11. The method of claim 10, wherein the listing of each provider includes an option that a rep can select to request an appointment for visiting the provider to market a product or service.

12. The method of claim 11, wherein the user interface provides an option for a provider to specify one or more times during which the provider is available to be visited, the method further comprising:
in response to the rep selecting the option to request an appointment with a provider, displaying the one or more specified times during which the provider is available to be visited.

13. The method of claim 1, further comprising:
displaying, in conjunction with the listing of a rep, an option that a provider can select to request a visit from the rep during which the rep will market the product or service indicated in the listing.

14. The method of claim 1, wherein the user interface provides an option for a provider to specify one or more times during which the provider is available to be visited to provide lunch while marketing a product or service, the method further comprising:
displaying within the user interface and to a rep the one or more times.

15. The method of claim 1, wherein the user interface provides an option for a provider to specify a maximum number of times that the provider is willing to be visited for marketing a particular product or service during a particular time period.

16. One or more computer storage media storing computer executable instructions which when executed perform a method for ensuring that a rep provides value to a provider, the method comprising:
displaying, in a user interface, a listing of a rep that is certified to market a product or service, the listing identifying the product or service that the rep is certified to market;
receiving user input from a provider that has been visited by the rep to market the product or service, the user input indicating that the rep violated at least one of one or more rules governing the certification of reps;
determining that the rep has committed a number of violations that meets a threshold; and
revoking the certification of the rep such that the rep is no longer listed in the user interface as being certified to market the product or service.

17. The computer storage media of claim 16, wherein the product or service is a drug.

18. The computer storage media of claim 16, wherein the method further comprises:
receiving user input from a second rep, the user input comprising the second rep's agreement to abide by the one or more rules governing the certification of reps to market a product or service; and
displaying, in the user interface, a listing of the second rep along with the product or service that the second rep is certified to market.

19. The computer storage media of claim 16, further comprising:
displaying, in the user interface, a listing of providers that have registered to receive visits from certified reps.

20. A system comprising:
one or more processors; and
one or more computer storage media storing computer executable instructions which when executed by the one or more processors implement a method for ensuring that a rep provides value to a provider, the method comprising:
displaying, in a user interface, a listing of a plurality of reps that have been certified to market a drug, each rep being listed with a drug that the rep markets, wherein a rep is certified by agreeing to abide by one or more rules when visiting a provider to market a drug;
displaying, in the user interface, a listing of a plurality of providers that have registered to receive visits from certified reps;
providing an option in the user interface for a rep to schedule a visit with a provider during which the rep will discuss the drug that the rep markets; and
providing an option in the user interface for a provider to report a violation of the one or more rules that a rep commits during a visit to the provider.
